(19) United States
(12) Patent Application Publication
(10) Pub. No.: US 2026/0122746 A1
(43) Pub. Date: Apr. 30, 2026

(54) DEVICE AND METHOD FOR GENERATING LIGHT SIGNALS AND/OR AUDIO SIGNALS WITHIN ENVIRONMENTS

(71) Applicant: Curious Amazing Holdings INC, Agoura Hills, CA (US)

(72) Inventor: Andrea Tellatin, Agoura Hills, CA (US)

(21) Appl. No.: 18/929,598

(22) Filed: Oct. 28, 2024

(51) Int. Cl. H05B 47/12; G06F 3/16; H05B 47/165

(52) U.S. Cl. CPC H05B 47/12; G06F 3/167; H05B 47/165

(57) ABSTRACT

Device for generating light signals and/or audio signals inside environments comprising a plurality of sensors arranged for detecting one or more parameters of the environment and/or one or more parameters of one or more users present in the environment in which the device is located, one or more lighting elements and/or one or more elements for emitting an audio signal.

A control unit arranged for controlling the activation of the lighting elements and/or of the elements for emitting an audio signal is provided, which control unit comprises at least one processing unit and at least one storage unit.

Said storage unit comprises association rules designed to associate the values of the detected parameters with a corresponding condition of the environment, a plurality of conditions Of the environment being provided,
the processing unit being configured to:
   identify a specific condition of the environment on the basis of the detected parameters,
   activate the lighting elements and/or the elements for emitting an audio signal on the basis of the specific condition of the environment.

The present invention relates to a device for generating light signals and/or audio signals within environments comprising a plurality of sensors configured for detecting one or more parameters of the environment and/or of one or more parameters of one or more users present in the environment in which the device is located.

Such device also comprises one or more lighting elements and/or one or more elements for emitting an audio signal, as well as a control unit configured to control the activation of the lighting elements and/or of the elements for emitting an audio signal.

In particular, the control unit comprises at least one processing unit and at least one storage unit.

The above described configuration is the common one of electronic devices known in the state of the art, that control the activation of lights or the emission of audio signals in an environment.

Typical examples of such devices are for example lamps or lighting elements used to create a specific atmosphere during the viewing of a film: based on the sounds emitted by the film and/or based on the brightness and colors of the scenes, the lamps known in the state of the art vary their lighting, through an adjustment of the light intensity and/or of the lighting colors to adapt to or to contrast the brightness or colors or the audio signals of the film.

All the devices known in the state of the art are therefore generally linked to the processing of a light signal or of an audio signal, but do not present an approach that takes into account the mood of the environment in which they are placed.

Furthermore, traditional lighting systems often lack the ability to adapt dynamically to the environment learning from the preferences of the users. Existing systems may offer limited or pre-defined automation, such as dimming based on time or simple motion detection or colors following, but they fall short in creating a truly responsive and personalized lighting experience.

There is therefore a need not satisfied by the systems known in the art to solve the above disadvantages, in particular to create a device for generating light signals and/or audio signals capable of modifying its behaviour by adapting to complex conditions of the environment coming from a mix of different inputs like sound, people's mood, environment light, etc, taken as a whole.

The present invention achieves the above purposes by realising a device as described above, wherein there are provided associative rules aimed at associating the values of the detected parameters with a corresponding condition of the environment, a plurality of conditions of the environment being provided.

Furthermore, the processing unit is configured to:
identify a specific condition of the environment on the basis of the detected parameters,
activate the lighting elements and/or the elements for emitting an audio signal in a predetermined manner on the basis of the condition of the environment.

According to a possible embodiment, such associative rules can be stored inside the storage unit.

The storage unit is one of the components of the device object of the present invention, as well as the processing unit, the elements for emitting an audio signal and the light elements.

All the components constituting the device object of the present invention can be inserted inside a single external casing or can be provided on separate objects that communicate with each other, so as to create a distributed system, configured to perform all the functions of the device object of the present invention that will be described.

Thanks to the parameters detected by the sensors, the device which is the subject of the present invention performs a classification of the environment, i.e. it identifies which environment condition between the possible environment conditions best associates with the environmental situation the users asked for.

As will be evident from the following description, the device object of the present invention does not provide for absolute associative rules and environmental conditions, such rules and such environmental conditions are subject to variations.

Preferably, such variations will be regulated through the execution of artificial intelligence and machine learning algorithms, as will be described later.

In the case of the device object of the present invention, it will therefore be possible for the same values of the parameters to give rise, at different times, to the association to two different environmental conditions and/or two different actions.

Each environmental condition corresponds therefore, to a setting of the lighting elements and/or the elements for emitting an audio signal, controlled by the control unit.

Preferably, this setting is aimed at balancing the environmental situation, that is, starting from the detected parameters, the activation of the lighting elements and/or the elements for emitting an audio signal will be such as to either emphasize such parameters or dampen their effect.

As will be evident, the device which is the object of the present invention allows to carry out a method which presents a final decision-making phase, preferably developed by artificial intelligence and machine learning algorithms, aimed at strengthening and/or increasing the mood of the environment, if positive, or dampening the mood of the environment, if negative, by modifying the functioning of the light elements and/or the elements emitting an audio signal, based on the decision-making choice made.

Some methods of using the device that is the subject of the present invention will be described later, precisely to describe the concept of setting.

One of the most advantageous aspects of the device that is the subject of the present invention is its dynamic behaviour, that is, the possibility of varying the associative rules between the detected parameters and the environmental conditions.

The device that is the subject of the present invention also allows the setting of the lighting elements and/or the elements for emitting an audio signal to be varied based on the environmental conditions.

Preferably, such variations are performed through machine learning and artificial intelligence algorithms.

Consequently, the device of the present invention is designed to enhance lighting and atmosphere in environments by intelligently responding to various environmental, biometric, and potentially vital parameters of the occupants. Utilizing advanced artificial intelligence techniques, the device can analyse the surrounding environment and adapt the lighting in real-time to optimize comfort and well-being. This device not only reacts to changes in the environment but also learns from user preferences, offering a unique and personalized experience.

The device of the present invention interprets and responds to environmental signals to create the ideal atmosphere. Whether it's a quiet evening, a lively party, or a moment of focused concentration, the device adapts its lighting or playing audio to support and enhance the mood and well-being of the people in the environment.

Consequently, the device is rooted in the concept of acquiring environmental parameters and biometric or vital signs from the inhabitants, processing these data, detecting the mood of the environment, and making AI-driven decisions to balance the mood through precise modulation of lighting and/or sound.

According to the described configuration, the device of the present invention stands apart by combining advanced sensor integration with cutting-edge artificial intelligence, enabling the system to interpret a wide range of environmental and biometric data in real-time.

Unlike conventional systems that rely on pre-set schedules, the device continuously learns and adapts to the nuances of its environment and the specific needs of its users. This results in an unparalleled level of personalization and dynamic response, making the device of the present invention not just a lighting solution, but an integral part of the living environment that enhances emotional well-being, supports various activities, and creates a truly immersive experience.

The device of the present invention offers dynamic adaptation of audio signal and/or of light intensity and color based on environmental conditions, user activities, and biometric feedback. By utilizing advanced sensors and AI algorithms, the system can fine-tune lighting and/or audio signals to match the exact needs of the moment, whether it's providing soft, warm light for relaxation or bright, cool light for concentration.

The AI-driven personalization ensures that the device responds to individual user preferences and the specific context of the environment. Over time, the system learns from users'interactions and adjusts its behaviour to malign with personal lighting and/or audio preferences, creating a unique and customized experience for each user.

Given the advantages set out above, the present invention also relates to a method for generating light signals and/or audio signals within an environment.

The method includes the following steps:
a) detection of one or more parameters of the environment and/or of one or more parameters of one or more users present in the environment,
b) processing of such parameters,
c) generation of light signals and/or audio signals.

In particular, step b) involves associating the values of the parameters detected in step a) with a specific condition of the environment, while step c) is implemented on the basis of the specific condition of the environment associated.

As described above, according to an improvement, the method steps described can be adjusted, at least in part, by machine learning and artificial intelligence algorithms.

In this way, a learning system is obtained in reading environmental parameters through the sensors, whose detection improves over time, but also a learning system on how these parameters are transformed into light and/or sound. According to the method of the present invention, the light and/or sound are modified in real time by a learning process performed by artificial intelligence algorithms.

One of the standout features of the device and of the method according to the present invention is its ability to quickly respond to changes in the environment and user biometrics. Whether the environment suddenly becomes more active or a user's biometric signals indicate stress, the lighting and audio command signals will be adjusted in real-time to maintain an optimal atmosphere, ensuring that the environment remains comfortable and supportive at all times.

These and further objects of the present invention are achieved through a device and a method according to the attached independent claims and subclaims.

These and other features and advantages of the present invention will be more clearly apparent from the following description of some illustrated embodiments in the attached drawings in which:

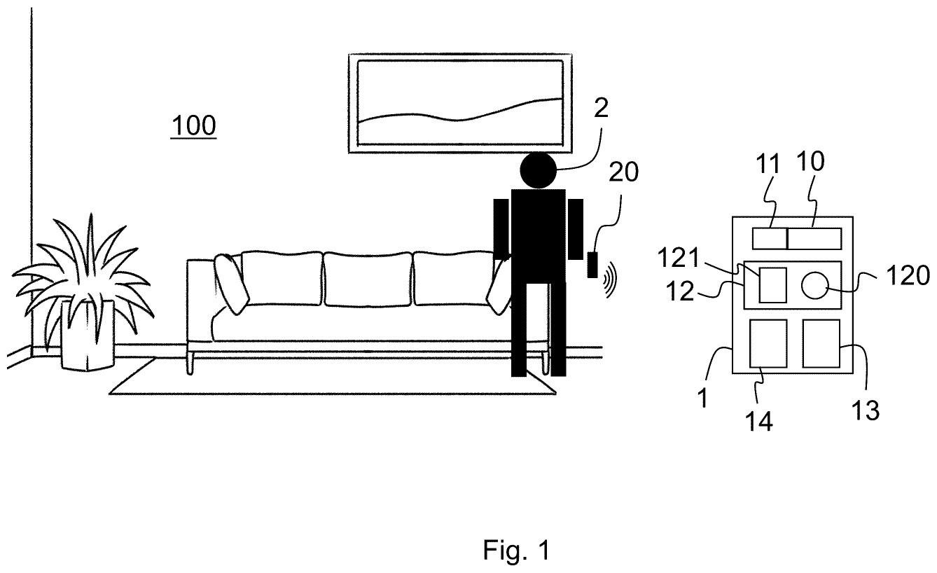

FIG. 1 illustrates a basic diagram aimed at illustrating the components of the device which is the object of the present invention;

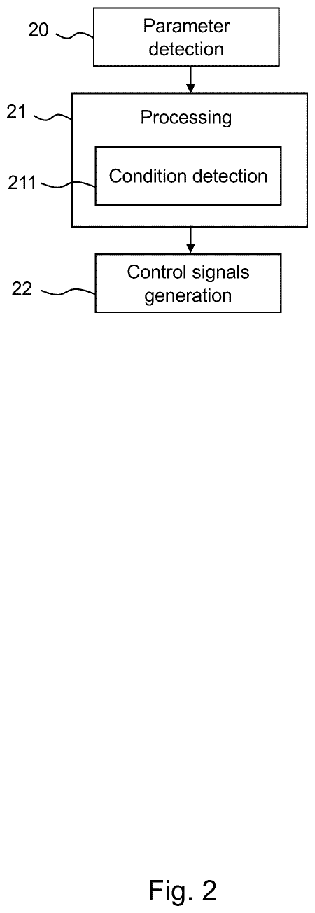

FIG. 2 illustrates, through a flow chart, a possible embodiment of the method which is the object of the present invention.

It is specified that the figures attached to the present patent application illustrate only some possible embodiments of the device and of the method for generating light signals and/or audio signals which are the object of the present invention, in order to better understand the advantages and characteristics described therein.

These embodiments are therefore to be understood for purely illustrative purposes and not as limiting to the inventive concept of the present invention, i.e. that of generating light effects and/or sound effects which change their activation by adapting to the conditions of the environment taken as a whole.

In particular, FIG. 1 illustrates a basic diagram of a possible embodiment of the device which is the subject of the present invention. The device 1 comprises a sensor system 10 which includes a plurality of sensors, described below, configured to detect one or more parameters of the environment 100 in which the device is positioned.

The sensor system 10 further comprises a communication unit 11 configured for communication with devices associated with the users present within the environment 100, such as a smartphone 20 associated with a user 2.

The communication unit 11 allows the device 1 to communicate with the smartphone 20 and with any other device associated with the users present in the environment, preferably, for the detection of biometric parameters of the users.

The communication between the communication unit 11 and the devices associated with the users preferably occurs in wireless mode, for example via Bluetooth.

The device 1 also comprises a control unit 12 configured to control the activation of one or more light elements 13 and/or one or more audio signal emission elements 14.

Both the light elements 13 and the audio signal emission elements 14 can be made according to any of the methods known in the state of the art.

The control unit 12 also comprises at least one processing unit 120 and a storage unit 121.

The storage unit 121 comprises associative rules aimed at associating the values of the detected parameters with a corresponding condition of the environment 100, a plurality of predetermined conditions of the environment 100 being provided.

The processing unit is instead configured to:
identify a specific condition of the environment 100 on the basis of the detected parameters,
activate the lighting elements and/or the elements for emitting an audio signal on the basis of the specific condition of the environment 100.

As anticipated, the operation of the device 1, i.e. the operation of the control unit 12 and, consequently, the activation of the lighting elements and/or the elements for emitting an audio signal, can be adjusted by the presence of machine learning and artificial intelligence algorithms within the control unit 12.

Furthermore, the device 1 comprises a source of power supply, not illustrated in the figures, consisting of a battery, preferably of the rechargeable type, and/or a connection circuit to the electrical distribution network of the environment 100.

As discussed above, the device according to the present invention leverages a combination of advanced sensors, sophisticated data processing techniques, and cutting-edge artificial intelligence to deliver an adaptive, responsive lighting system. The careful selection of these technologies enables the provision of a unique and personalized lighting experience that enhances both the emotional and functional atmosphere of any space.

The sensor system 10 comprises a plurality of sensors, which will be briefly described.

As discussed above, the sensor system 10 may include any sensor known in the state of the art and it is not limited to the sensors described below.

### Ambient Light Sensors

Ambient light sensors play a crucial role in measuring both the intensity and color spectrum of light in the environment. These sensors are typically based on photodiodes, which convert light into an electrical signal. The strength of these sensors lies in their ability to detect even subtle changes in the natural or artificial light within a space.

By accurately assessing these variations, the device 1 can optimize its lighting output to harmonize with the existing light, ensuring that the environment is illuminated in a way that is both energy-efficient and aesthetically pleasing. This capability allows for real-time adjustments that create a seamless and adaptive lighting experience.

### Acoustic Sensors

Acoustic sensors capture the soundscape of the environment, including conversations, music, and background noise. These sensors are usually equipped with microphones that convert sound waves into digital data, which can then be analyzed to assess the overall activity and mood in the room. The real strength of these sensors is their ability to gather detailed audio data that can be classified using machine learning algorithms to identify specific sounds, such as children playing, people arguing, or different genres of music. This classification allows the device 1 to tailor its lighting response to the auditory context, enhancing the user experience by matching the light ambiance to the detected sounds.

### Motion Sensors

Motion sensors detect the presence and movement of people in the environment, typically using passive infrared (PIR) technology. These sensors are essential for understanding the level of activity in a space, whether it is dynamic with lots of movement or calm with minimal activity. The data from these sensors enables the device 1 to adjust the lighting dynamically; for example, increasing brightness and color vibrancy in response to high activity or dimming the lights to maintain a tranquil atmosphere when there is little movement. The responsiveness of motion sensors ensures that the lighting system remains interactive and aligned with the behaviour of the occupants.

### Thermometers and Hygrometers

Thermometers and hygrometers measure the temperature and humidity of the air, providing a comprehensive understanding of the physical conditions in the environment. Thermometers typically use thermistors or infrared sensors, while hygrometers use capacitive or resistive elements. These sensors help the device 1 to adjust the lighting to enhance comfort; for example, cooler lighting might be preferred in a warm, humid room, while warmer lighting could make a cool, dry space feel more inviting. By factoring in these environmental conditions, the device 1 can make adjustments that improve the overall comfort and ambiance of the space.

According to the above described features, the device and method of the present invention integrate multiple data sources to provide a comprehensive understanding of the environment, enabling it to adapt the lighting accordingly.

Such data do not only derive from the environment parameters, but the device and method of the present invention take into account also external parameters.

### Just as an Example

Calendar: Information about the day of the week, holidays, and seasons that can influence the lighting preferences and needs (e.g., festive lighting during holidays).

### Clock

Time of day, sunrise, and sunset times, which are critical for synchronizing lighting with natural rhythms and optimizing for circadian cycles.

### Internet Services

Weather forecasts and other relevant external data can be used to adjust lighting based on expected environmental conditions, such as creating a warm ambiance on a cold day or enhancing brightness on a cloudy day.

FIG. 2 illustrates a flow diagram of a possible operation of the device 1, i.e. of an embodiment, from a generic point of view, of the method which is the subject of the present invention.

Once the device 1 is placed inside the environment 100, the sensors begin to detect one or more parameters of the environment and/or one or more parameters of one or more users inside the environment 100, step 30.

The data detected by the sensors are then processed, step 31, so as to generate command signals for the activation of the lighting elements and/or the elements for emitting an audio signal, i.e. for the generation of light signals and/or audio signals, step 32.

In the processing phase, step 31, the values of the parameters are analyzed so as to identify a specific environmental condition, step 311. Preferably, the environment 100 can be classified according to one or more environmental conditions, each presenting reference values of the one or more detected parameters, so that, on the basis of the values of the parameters detected in real time, it will be possible to identify a specific condition of the environment, step 311.

It follows that the generation step 32 of control signals of the light elements 13 and/or of the elements emitting an audio signal 14 is carried out on the basis of the condition of the environment 100 identified in step 311.

Also in this case, activation rules of the elements 13 and/or of the elements 14 will be provided, i.e. activation reference values for each environmental condition.

Some executive examples will be described below, but, for example, it is possible to vary the intensity or the color of the emitted light, just as it is possible to select a specific sound or a piece of music, increase or decrease its volume, always on the basis of the environmental condition.

Advantageously, the associative rules between the detected parameters and the environmental conditions, and between the environmental conditions the settings of the elements 13 and/or of the elements 14, can be modified through machine learning and artificial intelligence algorithms, as will be described later.

According to a possible embodiment, the processing step 31 comprises a data pre-processing for ensuring that the raw sensor data is clean and consistent before analysis. Effective pre-processing is critical for preparing the data for more complex analysis and decision-making processes.

Accordingly, once collected, the raw data needs to be pre-processed to ensure that it is accurate and ready for analysis. This step is responsible for filtering, cleaning, and normalizing the data.

### Consequently the Pre Processing Step Can Provide For

Noise Filtering: Acoustic data is filtered to remove background noise and isolate relevant sounds. For example, Fast Fourier Transform (FFT) is used to decompose acoustic signals into frequencies, allowing relevant patterns to be identified.

Light Normalization: Light readings are normalized to ensure that the data is comparable regardless of initial lighting conditions. This process is essential to ensure that the lighting elements 13 adapt correctly to the environment.

### Motion Processing

Motion data is analyzed to classify the activity in the room, distinguishing between light and intense movements, which require different lighting responses.

Environmental Data Correction: Temperature and humidity data are stabilized and corrected to accurately reflect environmental conditions, providing a complete picture for subsequent analysis.

### Temporal Data Handling

Information from the calendar and clock is processed to determine appropriate lighting based on the time of day, season, and upcoming events.

After this phase, the association between the values of the parameter and the detection of the environment condition is carried out though machine learning algorithm, in order to classify and respond to different environmental states.

For audio classification, specific algorithms such as convolutional neural networks (CNNs) and recurrent neural networks (RNNs) are particularly effective. These algorithms are well-suited for identifying specific sound patterns, such as distinguishing between children playing, people arguing, or music genres like classical or rock. By accurately classifying these sounds, the device 1 can adapt its lighting in real-time to create an environment that complements the auditory landscape, whether it's calming lighting during a quiet reading session or dynamic lighting for a lively gathering.

Furthermore both the processing step 31 and the generation of light signals step 32 employ advanced AI techniques, including the use of large language models (LLMs). These models are highly effective at understanding complex patterns and making decisions based on a wide range of inputs. The use of LLMs allows the device 1 to interpret analyzed data holistically, considering not just isolated data, but the broader context of the environment. This enables the system to make more sophisticated decisions about how to adapt the lighting to meet the user's needs. For example, LLMs can help to anticipate user preferences based on previous interactions or even suggest lighting adjustments that align with the mood inferred from the environment. The ability to leverage LLMs makes the device 1 not only reactive but also proactive, offering a more personalized and intelligent lighting experience that evolves with the user's habits and preferences.

Consequently, the pre-processed data is analyzed to understand the current state of the environment as described for step 211. The environmental analysis uses machine learning-based classifiers to categorize environmental conditions and provide a detailed picture that will inform subsequent decisions:

### Environment Classification

Machine learning algorithms, such as decision trees or support vector machines, are used to classify the environment into categories such as relaxed, active, stressed, etc. These classifications guide decisions on how to adjust the lighting.

### Pattern Recognition in Acoustic Data

A thorough analysis of sound data is performed to identify specific situations, such as a festive or tranquil environment. This information is crucial in determining how to adjust the lighting to enhance or maintain the desired atmosphere.

Stability Evaluation: it provides for a continuous monitoring of the environmental data to detect significant changes over time, such as fluctuations in noise levels or lighting. These changes determine whether lighting adjustments are needed to maintain an optimal atmosphere.

After the processing step 21, the step 22 is carried out through AI techniques.

Based on the results of the environmental analysis, AI-driven decision-making determines how to adapt the lighting to ensure a personalized and contextually appropriate experience:

### Deep Personalization

The AI analyzes structured data, such as matrices of environmental characteristics and historical user preferences, to decide on the optimal lighting configuration. AI techniques such as decision trees and random forests support this personalization, ensuring that the lighting responds precisely and contextually.

### Transition Planning

AI plans change in light intensity and color using temporal interpolation and smoothing techniques to ensure that transitions are smooth and do not disrupt the atmosphere. The use of keyframe animation and temporal smoothing algorithms ensures that lighting changes are gradual and harmonious.

### Dynamic Adaptation

AI enables real-time adaptation of lighting, quickly responding to environmental changes. Event-driven systems and real-time data processing techniques allow AI to promptly react to changes and maintain an optimal atmosphere.

Once decisions are made the control unit 12, through the lighting elements 13, executes the instructions to modify the lighting in alignment with the environment's needs and user preferences:

### Light Intensity and Color Adjustment

The control unit 12 adjusts the intensity and color of the light according to the instructions received from the AI, utilizing a range of tones from relaxing to more stimulating colors, depending on the context.

### Execution of Dynamic Effects

The control unit implements smooth transitions between colors and light intensity and generates special effects such as pulses or synchronization with audio to enhance the room's overall atmosphere.

### Real-Time Monitoring and Correction

The device 1 continuously monitors the effectiveness of the applied changes and can make immediate corrections to ensure that the lighting remains optimal as environmental conditions evolve.

Based on what has been discussed above, some possible examples of operation of the device and the method object of the present invention will be described below.

Particular attention will be paid to the description of the scenario, the type of data detected and their pre-processing, the analysis of the environment and the settings of the light elements

### 1) Relaxing Evening

### Scenario Overview

The “Relaxing Evening” scenario takes place in a home setting as the day winds down. The user seeks to create a serene and calming environment to unwind after a busy day. The room is dimly lit, reflecting a desire for peace and relaxation. Soft background noise, such as music, adds to the ambiance, and minimal movement suggests a tranquil setting. The objective of in this scenario is to enhance and maintain this calm atmosphere through gentle, warm lighting that soothes the senses and supports relaxation. The product must interpret environmental cues and user preferences to create a seamless and immersive experience that aligns with the user's desire to relax.

### Data Sources

### Sensors Data

Ambient Light Sensor: Measures low light intensity levels (lux values).
Acoustic Sensor: Captures audio signals, including low-volume, low-frequency sound waves (dB levels).
Motion Sensor: Detects minimal movement, providing data on motion intensity and frequency (motion index).

### Data Sources

Clock: Provides the current time, confirming that it is evening.
Calendar: Indicates the day, possibly showing it is a weekend or holiday.

### Data Collection

Objective: Capture real-time environmental data from sensors to provide a comprehensive snapshot of the current room conditions.

### Process

Ambient Light: The sensor continuously records light intensity, capturing lux values that indicate a dimly lit environment.
Acoustic: The sensor picks up audio signals across a range of frequencies, storing raw data on sound levels and patterns.
Motion: The sensor detects and records movement, quantifying the frequency and intensity of motion in the room.
Temporal Data: Time and calendar information are fetched to contextualize the data, confirming the evening setting and potentially a relaxing day like a weekend.
Output: A collection of raw data sets, including lux levels, audio signal data (frequency and amplitude), motion index, and temporal information, reflecting the environment's current state.

### Data Pre-Processing

Objective: Clean, filter, and normalize the raw sensors data to prepare it for accurate analysis.

### Process

Noise Filtering (Acoustic): Apply FFT to the audio data to isolate relevant low-frequency patterns, filtering out background noise.
Light Normalization: Normalize lux readings to correct for any sensor bias, ensuring the data accurately reflects the dim lighting.
Motion Data Processing: Smooth the motion data using a low-pass filter to reduce noise and confirm minimal activity.
Temporal Data Integration: Convert time and calendar data into usable indices to correlate with the evening and potentially relaxed timeframes.
Output: Cleaned and normalized datasets for light intensity, audio frequencies, motion data, and temporal context, prepared for analysis.

### Environmental Analysis

Objective: Analyze the pre-processed data to classify the environment's mood and determine its stability.

### Process

Environment Classification: Utilize a decision tree classifier to analyze the normalized light, sound, and motion data, classifying the environment as “Relaxed” based on low light intensity, calm audio patterns, and minimal movement.
Pattern Recognition: Cross-reference the acoustic data with stored profiles to confirm the presence of a calm, relaxing audio pattern.
Stability Evaluation: Assess the consistency of the classified data over time to ensure the environment's relaxed state is stable and unlikely to fluctuate.
Output: Classification of the environment as “Relaxed,” with stable mood parameters ready to inform the next phase of decision-making.

### Decision and Planning

Objective: Develop a lighting strategy that enhances and sustains the relaxed atmosphere.

### Process

Personalization: Analyze historical user preferences for relaxation settings. Set the light color temperature to 2700K and light intensity to 30%, based on past data that shows these settings are conducive to relaxation.
Transition Planning: Calculate smooth transitions in light intensity and color to avoid abrupt changes that could disrupt the calm atmosphere.
Dynamic Adaptation: Establish thresholds for minor environmental changes (e.g., slight increases in movement or sound) that would trigger subtle lighting adjustments if necessary.
Output: Specific instructions to adjust lighting to a color temperature of 2700K, light intensity of 30%, and a gradual transition profile.

### Lighting Control

Objective: Implement the lighting strategy to achieve the desired relaxed environment.

### Process

Actuation: Adjust the LED drivers to achieve the specified 2700K color temperature and 30% light intensity, creating a warm, soft light.
Effect Execution: Use PWM control to execute the calculated smooth transitions in lighting, maintaining the relaxed mood.
Real-Time Monitoring: Continuously monitor sensor feedback, dynamically adjusting the lighting if any deviations from the relaxed state are detected.
Output: Actuated lighting system that produces soft, warm light with smooth transitions, ensuring a serene and calming environment.

### 2) Party With Friends

### Scenario Overview

In the “Party with Friends” scenario, the device transforms the environment into a lively and energetic space that matches the social atmosphere of a gathering. The room is brightly lit, filled with rhythmic music, and bustling with movement as guests socialize. The goal for the device in this setting is to amplify the festive mood by synchronizing dynamic, colorful lighting with the rhythm of the music and the room's energy. The device must interpret the high activity levels and audio patterns from sensors and data sources to create a visually engaging and immersive party atmosphere.

### Data Sources

### Sensor Data

Ambient Light Sensor: Measures high light intensity levels, indicating a brightly lit environment.
Acoustic Sensor: Captures high-volume, rhythmic audio signals, providing raw data on sound frequency and amplitude.
Motion Sensor: Detects frequent, high-intensity movement, quantifying motion patterns that suggest active social interaction.

### Data Sources

Clock and Calendar: Provide time and day data, confirming it is evening and potentially a weekend, typical times for social gatherings.

### Data Collection

Objective: Capture real-time environmental data to provide a comprehensive understanding of the lively, social setting.

### Process

Ambient Light: Continuously records lux values to confirm the high light levels typical of a party environment.
Acoustic: Records audio signals, capturing the rhythmic patterns and high volume characteristic of party music.
Motion: Records high motion intensity, analyzing the frequency and amplitude of movements in the room.
Temporal Data: Time and calendar information are retrieved to confirm the context of a social event.
Output: A set of raw data, including high lux levels, detailed audio signal data (frequency, amplitude), motion intensity index, and time/day information.

### Data Pre-Processing

Objective: Process and normalize the raw data to accurately represent the high-energy environment.

### Process

Noise Filtering (Acoustic): Apply FFT to the audio data to isolate rhythmic patterns from other noise, ensuring the music is accurately represented.
Light Normalization: Normalize high lux readings to ensure consistency across different sensor readings, confirming the bright lighting.
Motion Data Processing: Smooth the motion data to provide a clear, accurate representation of sustained high activity.
Temporal Data Integration: Align time and calendar data with expected patterns of social activity, such as evening or weekend gatherings.
Output: Pre-processed data that reflects the lively, dynamic environment, ready for further analysis.

### Environmental Analysis

Objective: Analyze the pre-processed data to confirm the party atmosphere and its stability.

### Process

Environment Classification: Use an SVM classifier to categorize the environment as “Lively,” based on high light levels, rhythmic audio patterns, and active motion.
   Pattern Recognition: Identify and Confirm Rhythmic patterns typical of social events, reinforcing the “Lively”classification.
Stability Evaluation: Assess the consistency of high activity and sound levels over time to confirm a stable party environment.
Output: Classification of the environment as “Lively,” providing parameters for dynamic lighting control decisions.

### Decision and Planning

Objective: Create a dynamic lighting strategy that enhances the party atmosphere and matches the energy of the event.

### Process

Personalization: Configure lighting to include vibrant RGB colors and high brightness levels. Set synchronization parameters to match the lighting changes with the music's rhythm.
Transition Planning: Calculate rapid transitions and dynamic effects to keep pace with the music tempo and movement in the room.
Dynamic Adaptation: Establish adaptive thresholds to adjust lighting in real-time based on changes in music tempo or shifts in activity, ensuring the atmosphere remains lively and engaging.
Output: Specific instructions for RGB color settings, brightness levels, and synchronization with the music's rhythm, ready for execution.

### Lighting Control

Objective: Implement the dynamic lighting strategy to maintain the high-energy party atmosphere.

### Process

Actuation: Drive the RGB LEDs to produce the specified colors and brightness levels, ensuring synchronization with the music's beat.
Effect Execution: Implement rapid lighting transitions and effects using PWM modulation, ensuring the lighting enhances the party atmosphere.
Real-Time Monitoring: Continuously monitor sensor feedback, adjusting lighting effects dynamically to match any changes in the environment.
Output: Actuated lighting system that produces vibrant, dynamic lighting effects, perfectly synchronized with the music, creating an immersive and engaging party environment.

### 3) Concentration Moment

### Scenario Overview

The “Concentration Moment” scenario is set during focused work or study, where the environment is quiet and free from distractions. The user needs consistent and supportive lighting that minimizes eye strain and enhances concentration. The room is moderately lit with natural light, and there is minimal movement, reflecting a calm and focused setting. The device's goal is to maintain a steady, cool light that fosters concentration and productivity while ensuring that the environment remains distraction-free. The product must interpret low activity levels and quiet audio environments to create a lighting profile that supports sustained focus.

### Data Sources

### Sensors Data

Ambient Light Sensor: Measures moderate light intensity levels, indicating a well-lit environment conducive to focus.
Acoustic Sensor: Captures low audio levels, detecting near silence or minimal background noise.
Motion Sensor: Detects minimal movement, providing data on the lack of distractions.

### Data Sources

Clock: Provides data indicating that it is daytime, during typical working or studying hours.

### Data Collection

Objective: Collect real-time environmental data to assess the suitability of the room for concentration and focus.

### Process

Ambient Light: Records moderate lux values that align with optimal lighting for reading or working.
Acoustic: Collects audio signals to confirm the quiet environment, focusing on low dB levels indicating minimal noise.
Motion: Captures data on minimal movement, confirming a low-distraction setting.
Temporal Data: Time data is retrieved to confirm that the environment aligns with typical productive hours.
Output: A set of raw data, including moderate lux levels, low audio signal data (dB levels), motion index, and time data, reflecting a conducive environment for focus.

### Data Pre-processing

Objective: Clean and normalize the raw data to ensure accurate representation of the focused environment.

### Process

Noise Filtering (Acoustic): Filter out any minor background noise to confirm the near silence, ensuring the environment is distraction-free.
Light Normalization: Normalize moderate lux readings to ensure proper calibration for focused lighting needs.
Motion Data Processing: Smooth motion data to confirm the consistent lack of distractions.
Temporal Data Integration: Integrate time data to align lighting needs with the typical work or study schedule. Output: Pre-processed data that accurately reflects a quiet, focused environment, ready for analysis.

### Environmental Analysis

Objective: Analyze the pre-processed data to confirm the environment's suitability for concentration.

### Process

Environment Classification: Use a random forest classifier to categorize the environment as “Focused,” based on moderate light, low noise, and minimal motion.
Pattern Recognition: Confirm the absence of distractions in audio and motion data, validating the environment's focus-supporting qualities.
Stability Evaluation: Ensure that environmental parameters remain stable to support ongoing concentration.
Output: Classification of the environment as “Focused,” providing specific parameters for decision-making.

### Decision and Planning

Objective: Develop a lighting strategy that supports and sustains concentration and productivity.

### Process

Personalization: Configure lighting to a cool color temperature (e.g., 4000K) and set light intensity to 80%, ensuring that the lighting is conducive to focus.
Transition Planning: Plan for minimal changes in lighting, maintaining consistency to avoid distractions.
Dynamic Adaptation: Prepare to make minor adjustments if environmental noise or movement increases, ensuring continued focus.
Output: Specific instructions to set the color temperature to 4000K and light intensity to 80%, maintaining a steady, cool light profile.

### Lighting Control

Objective: Implement the lighting strategy to maintain the focused environment.

### Process

Actuation: Adjust the LED drivers to produce cool, steady lighting with a color temperature of 4000K and an intensity of 80%.
Effect Execution: Maintain consistent lighting with minimal fluctuations, using stable PWM signals to avoid any disruptions.
Real-Time Monitoring: Continuously monitor sensor feedback, dynamically adjusting the lighting if necessary to ensure the environment remains conducive to concentration.
Output: Actuated lighting system that provides cool, steady light, optimizing the environment for concentration and productivity.

### 4) Morning Relaxation

### Scenario Overview

The “Morning Relaxation” scenario occurs in a home environment where the user seeks a gentle and peaceful start to their day. The room is softly lit by natural morning light, and there are quiet background sounds, possibly from nature or light music. Movement is minimal, reflecting a slow, calm beginning to the day. The objective of the device in this scenario is to complement the natural light with warm, gradual illumination that enhances the relaxing morning atmosphere. The product must interpret the soft light, minimal activity, and calming sounds to create a lighting profile that supports a smooth and stress-free start to the day.

### Data Sources

### Sensors Data

Ambient Light Sensor: Measures soft, low-to-moderate light intensity, reflecting natural morning light.
Acoustic Sensor: Captures low-level, consistent background sounds, such as soft music or natural ambient noises.
Motion Sensor: Detects light, slow movement, indicating minimal activity.

### Data Sources

Clock: Provides the current time, confirming it is morning.
Calendar: Indicates whether it is a weekend, potentially influencing a more relaxed morning routine.

### Data Collection

Objective: Capture real-time environmental data to understand the current state of the room during the morning.

### Process

Ambient Light: Records low-to-moderate lux values, consistent with soft morning light entering the room.
Acoustic: Captures audio signals at low dB levels, indicating a quiet environment with calming background sounds.
Motion: Monitors for gentle movement, registering low motion intensity, which aligns with a slow, relaxed morning pace.
Temporal Data: Time and calendar data are retrieved to contextualize the environment as a relaxed morning setting.
Output: A set of raw data, including low-to-moderate lux levels, low audio signal data (dB levels), motion index, and temporal context, reflecting the calm morning environment.

### Data Pre-Processing

Objective: Process and normalize the collected data to ensure it accurately represents the relaxed morning atmosphere.

### Process

Noise Filtering (Acoustic): Apply FFT to isolate consistent, low-frequency sounds, filtering out any transient noise, focusing on soft, soothing sounds.
Light Normalization: Normalize lux readings to account for sensor variability, ensuring accurate representation of the soft morning light.
Motion Data Processing: Smooth motion data to confirm the gentle, slow movement characteristic of a relaxed morning.
Temporal Data Integration: Align time and calendar data with typical morning routines, reinforcing the relaxed context.
Output: A set of pre-processed data that accurately reflects the soft, calm morning environment, prepared for analysis.

### Environmental Analysis

Objective: Analyze the pre-processed data to classify the environment as conducive to a relaxed morning routine.

### Process

Environment Classification: Use a decision tree classifier to analyze the data, categorizing the environment as “Morning Relaxation” based on the soft light, low audio levels, and gentle movement.
Pattern Recognition: Identify and confirm the presence of soothing acoustic patterns typical of a calm morning setting.
Stability Evaluation: Check the consistency of the low activity and sound levels over time, ensuring that the relaxed state is stable.
Output: Classification of the environment as “Morning Relaxation,” providing a stable mood profile for lighting control.

### Decision and Planning

Objective: Develop a lighting strategy that enhances the natural morning light and supports a calm start to the day.

### Process

Personalization: Set the lighting to a warm color temperature (e.g., 3000K) with low intensity (e.g., 40%) to complement the soft natural light and create a cozy, welcoming environment.
Transition Planning: Plan gradual transitions in light intensity to slowly increase brightness as the morning progresses, avoiding any sudden changes that could disrupt the calm atmosphere.
Dynamic Adaptation: Prepare for subtle adjustments if movement or sound levels increase, ensuring the lighting remains supportive of relaxation.
Output: Detailed instructions to set the light color temperature to 3000K, intensity to 40%, and implement gradual brightness transitions throughout the morning.

### Lighting Control

Objective: Implement the lighting strategy to maintain and enhance the relaxed morning atmosphere.

### Process

Actuation: Adjust the LED drivers to produce warm, soft light with a color temperature of 3000K and an intensity of 40%, aligning with the natural light in the room.
Effect Execution: Use PWM control to implement the planned gradual transitions, slowly increasing brightness to match the natural progression of morning light.
Real-Time Monitoring: Continuously monitor sensor feedback to ensure the lighting remains appropriate, making dynamic adjustments if there are changes in movement or noise.
Output: Actuated lighting system producing warm, gentle light that gradually brightens, supporting a peaceful and relaxed morning atmosphere.

### 5) Intimate Dinner

### Scenario Overview

The “Intimate Dinner” scenario occurs in a dining setting where the user desires a cozy and inviting atmosphere for a small gathering or romantic meal. The room is dimly lit to create a sense of warmth and privacy, with soft, ambient background music adding to the ambiance. Movement is moderate, reflecting conversation and interaction around the table. The goal for the device in this scenario is to maintain and enhance the intimate setting by providing soft, warm lighting that complements the dining experience. The product must interpret the low light levels, soft sounds, and moderate activity to create a lighting profile that reinforces the desired atmosphere.

### Data Sources

### Sensors Data

Ambient Light Sensor: Detects low light intensity levels, consistent with a dimly lit dining environment.
Acoustic Sensor: Captures low-volume, ambient audio signals, indicating soft background music or conversation.
Motion Sensor: Registers moderate movement, reflecting interaction and activity around the table.

### Data Sources

Clock: Provides data confirming the time, likely during dinner hours.
Calendar: May indicate a special occasion, such as a holiday or anniversary, potentially influencing the lighting preferences.

### Data Collection

Objective: Capture real-time environmental data to assess the current state of the dining environment.

### Process

Ambient Light: Records low lux values, indicating dim lighting suited for an intimate setting.
Acoustic: Captures audio signals at low-to-moderate dB levels, identifying background sounds that contribute to the atmosphere.
Motion: Monitors moderate movement, quantifying the interaction around the table.
Temporal Data: Time and calendar information are retrieved to contextualize the environment as a dinner setting.
Output: A set of raw data, including low lux levels, ambient audio signal data (dB levels), motion index, and time/calendar information.

### Data Pre-Processing

Objective: Process and normalize the raw data to ensure it accurately represents the intimate dining environment.

### Process

Noise Filtering (Acoustic): Apply FFT to isolate the consistent, low-volume ambient sounds, filtering out background noise.
Light Normalization: Normalize lux readings to account for sensor variability, ensuring accurate representation of the dim lighting.
Motion Data Processing: Smooth motion data to confirm the moderate, consistent activity typical of a dining experience.
Temporal Data Integration: Align time and calendar data with typical dining hours and potential special occasions, reinforcing the context.
Output: A set of pre-processed data that accurately reflects the intimate dining environment, prepared for analysis.

### Environmental Analysis

Objective: Analyze the pre-processed data to classify the environment as conducive to an intimate dining experience.

### Process

Environment Classification: Use a decision tree classifier to categorize the environment as “Intimate” based on the low light levels, ambient audio, and moderate motion.
Pattern Recognition: Identify and confirm the presence of consistent ambient sounds, such as soft music or conversation, reinforcing the intimate setting.
Stability Evaluation: Check the consistency of the data over time to ensure the environment remains stable and supports the intimate atmosphere.
Output: Classification of the environment as “Intimate,” providing parameters for lighting control that enhances the dining experience.

### Decision and Planning

Objective: Develop a lighting strategy that enhances the intimate dining atmosphere and complements the overall experience.

### Process

Personalization: Set the lighting to a warm color temperature (e.g., 2700K) with low intensity (e.g., 20%) to create a cozy, inviting environment.
Transition Planning: Plan for subtle transitions in light intensity to adapt to the flow of the evening, maintaining a consistent, intimate ambiance.
Dynamic Adaptation: Prepare to adjust lighting dynamically if there are changes in conversation volume or activity, ensuring the lighting continues to support the intimate mood.
Output: Detailed instructions to set the light color temperature to 2700K, intensity to 20%, with subtle transition profiles.

### Lighting Control

Objective: Implement the lighting strategy to maintain and enhance the intimate dining atmosphere.

### Process

Actuation: Adjust the LED drivers to produce warm, soft light with a color temperature of 2700K and an intensity of 20%, matching the desired cozy environment.
Effect Execution: Use PWM control to execute the planned subtle transitions in lighting, ensuring the atmosphere remains intimate and inviting.
Real-Time Monitoring: Continuously monitor sensor feedback, dynamically adjusting the lighting as necessary to respond to changes in the environment.
Output: Actuated lighting system producing warm, soft light that subtly adapts to the flow of the evening, enhancing the intimate dining experience.

### 6) Focused Study Session

### Scenario Overview

The “Focused Study Session” scenario is set during a period of intense concentration, such as studying for an exam or working on a detailed project. The user requires a well-lit, distraction-free environment that enhances their ability to focus for extended periods. The room is typically lit with cool, bright light to keep the user alert, and there is minimal movement, reflecting deep concentration. The objective of the device in this scenario is to maintain a steady, bright light that reduces eye strain and supports sustained focus, while ensuring that the environment remains free from distractions.

### Data Sources

### Sensors Data

Ambient Light Sensor: Measures moderate-to-high light intensity levels, indicating a well-lit environment suited for focus.
Acoustic Sensor: Captures low audio levels, indicating a quiet or near-silent environment.
Motion Sensor: Detects minimal movement, suggesting a stationary activity, such as reading or writing.

### Data Sources

Clock: Provides data indicating that it is daytime, aligning with typical study or work hours.

### Data Collection

Objective: Capture real-time environmental data to assess the suitability of the room for focused work or study.

### Process

Ambient Light: Records moderate-to-high lux values that are optimal for tasks requiring focus and concentration.
Acoustic: Collects audio signals to confirm the low noise levels, focusing on maintaining a quiet environment.
Motion: Monitors minimal movement data, confirming that the user is engaged in a stationary, focused activity.
Temporal Data: Time data is retrieved to ensure that the lighting setup aligns with productive daylight hours.
Output: A set of raw data, including moderate-to-high lux levels, low audio signal data (dB levels), minimal motion index, and time data, reflecting a conducive environment for concentration.

### Data Pre-Processing

Objective: Clean and normalize the raw data to ensure it accurately represents a focused study environment.

### Process

Noise Filtering (Acoustic): Apply FFT to remove any minor background noise, ensuring the environment remains distraction-free.
Light Normalization: Normalize moderate-to-high lux readings to ensure consistent light levels that reduce eye strain.
Motion Data Processing: Smooth motion data to confirm the lack of distractions and steady focus.
Temporal Data Integration: Integrate time data to align the lighting with the study or work schedule, reinforcing the focus-supportive environment.
Output: Pre-processed data that accurately reflects a quiet, well-lit environment conducive to concentration.

### Environmental Analysis

Objective: Analyze the pre-processed data to confirm the environment's suitability for concentration and sustained focus.

### Process

Environment Classification: Use a random forest classifier to categorize the environment as “Focused,” based on bright light, low noise, and minimal motion.
Pattern Recognition: Confirm the absence of distractions in audio and motion data, validating the environment as supportive of concentration.
Stability Evaluation: Ensure that environmental parameters remain stable over time, supporting ongoing focus.
Output: Classification of the environment as “Focused,” providing specific parameters for maintaining a study or work-friendly atmosphere.

### Decision and Planning

Objective: Develop a lighting strategy that supports and sustains concentration and productivity.

### Process

Personalization: Set the lighting to a cool color temperature (e.g., 4000K) and adjust light intensity to 80%, ensuring that the environment is bright and conducive to focus.
Transition Planning: Plan for minimal changes in lighting to maintain consistency and avoid distractions.
Dynamic Adaptation: Prepare to make minor adjustments if environmental noise or movement increases, ensuring continued focus.
Output: Specific instructions to set the color temperature to 4000K, light intensity to 80%, and maintain consistent lighting to support focus.

### Lighting Control

Objective: Implement the lighting strategy to maintain a distraction-free, focused environment.

### Process

Actuation: Adjust the LED drivers to produce cool, steady lighting with a color temperature of 4000K and an intensity of 80%.
Effect Execution: Maintain consistent lighting with minimal fluctuations, using stable PWM signals to avoid any disruptions.
Real-time Monitoring: Continuously monitor sensor feedback, dynamically adjusting the lighting as necessary to ensure the environment remains conducive to concentration.
Output: Actuated lighting system providing cool, steady light, optimizing the environment for concentration and productivity.

### 7) Preparing for a Party

### Scenario Overview

In the “Preparing for a Party” scenario, the user is setting up for an upcoming event. The environment is transitioning from a regular home setting to one that is vibrant and energetic, suitable for a social gathering. As the preparations progress, the room becomes brighter and more dynamic, with music playing and increased movement as decorations are arranged, and seating is adjusted. The role of the device is to adapt the lighting gradually to match the increasing energy in the room, ensuring that the environment transitions smoothly from a calm setup phase to an energetic party atmosphere.

### Data Sources

### Sensors Data

Ambient Light Sensor: Measures gradually increasing light intensity as the environment is prepared for the party.
Acoustic Sensor: Captures rising audio levels, detecting the onset of music and other preparatory sounds.
Motion Sensor: Detects increasing movement, indicating active preparations such as arranging furniture and decorations.

### Data Sources

Clock and Calendar: Provide time and date data, confirming that the preparations align with the expected timing of the event.

### Data Collection

Objective: Capture real-time data that reflects the transition from a calm setup phase to an energetic party environment.

### Process

Ambient Light: Continuously records lux values, tracking the increase in brightness as the room is prepared for the party.
Acoustic: Captures audio signals to monitor the rise in sound levels as music starts playing and activity increases.
Motion: Monitors the increase in movement intensity, reflecting the active preparations for the event.
Temporal Data: Time and calendar data are retrieved to ensure the lighting adapts appropriately as the event approaches.
Output: A set of raw data, including increasing lux levels, rising audio signal data (dB levels), motion index, and time/calendar information.

### Data Pre-Processing

Objective: Process and normalize the data to ensure it accurately represents the transition toward a party atmosphere.

### Process

Noise Filtering (Acoustic): Apply FFT to focus on relevant sounds, filtering out any non-essential noise, ensuring accurate tracking of the rising energy levels.
Light Normalization: Normalize lux readings to track the increase in brightness, ensuring consistent light levels as the room transitions.
Motion Data Processing: Smooth motion data to accurately represent the increase in activity and preparations.
Temporal Data Integration: Align time and calendar data with the expected timeline of party preparations, reinforcing the transition context.
Output: Pre-processed data reflecting the transition from setup to party readiness, ready for further analysis.

### Environmental Analysis

Objective: Analyze the pre-processed data to confirm the environment's readiness for a transition to a party atmosphere.

### Process

Environment Classification: Use a dynamic classifier to categorize the environment as “Transition to Party,” based on increasing light levels, rising audio patterns, and active motion.
Pattern Recognition: Identify and confirm the increase in energy through the analysis of motion and sound patterns, validating the transition state.
Stability Evaluation: Monitor the consistency of the transition, ensuring that the environment is steadily moving toward a party-ready state.
Output: Classification of the environment as “Transition to Party,” providing parameters for dynamic lighting adjustments to facilitate the transition.

### Decision and Planning

Objective: Develop a lighting strategy that supports the transition from preparation to an energetic party atmosphere.

### Process

Personalization: Gradually adjust the lighting to increase brightness and incorporate dynamic colors (e.g., RGB effects) as the preparations progress, aligning with the rising energy levels.
Transition Planning: Plan for gradual increases in light intensity and dynamic color effects to smoothly transition the environment from setup to party mode.
Dynamic Adaptation: Prepare to adjust lighting dynamically in response to continued increases in activity and sound levels, ensuring a seamless transition.
Output: Specific instructions to gradually increase brightness, introduce dynamic RGB lighting effects, and transition smoothly into the party atmosphere.

### Lighting Control

Objective: Implement the lighting strategy to support the smooth transition from preparation to a vibrant party environment.

### Process

Actuation: Gradually adjust the LED drivers to increase light intensity and introduce dynamic RGB effects, reflecting the increasing energy in the room.
Effect Execution: Use PWM control to manage the smooth transition from setup lighting to vibrant party lighting, ensuring the transition is seamless.
Real-Time Monitoring: Continuously monitor sensor feedback, dynamically adjusting the lighting to match the ongoing preparations and increasing energy levels.
Output: Actuated lighting system that supports the transition from a calm setup phase to an energetic party environment, ensuring the room is party-ready.

### 8) Quiet Reading Evening

### Scenario Overview

In the “Quiet Reading Evening” scenario, the user seeks a peaceful and focused environment for reading. The room is softly lit, providing just enough light for comfortable reading without creating harsh glare or eye strain. The environment is quiet, with little to no background noise, and the user is stationary, fully absorbed in their book. The objective of the device is to maintain a soft, warm light that is easy on the eyes and conducive to long periods of reading, while ensuring that the environment remains quiet and free from distractions.

### Data Sources

### Sensors Data

Ambient Light Sensor: Measures low-to-moderate light intensity, providing sufficient illumination for reading.
Acoustic Sensor: Captures minimal audio levels, indicating a quiet environment ideal for concentration.
Motion Sensor: Detects very little movement, confirming the user's stationary activity.

### Data Sources

Clock: Provides time data to ensure the lighting matches the evening setting, promoting relaxation.

### Data Collection

Objective: Capture real-time environmental data to assess and maintain an optimal reading environment.

### Process

Ambient Light: Records low-to-moderate lux values that provide the necessary light for reading without causing eye strain.
Acoustic: Collects audio signals to confirm the quiet environment, focusing on maintaining low dB levels.
Motion: Monitors minimal movement, confirming the user's focus on reading and the absence of distractions.
Temporal Data: Time data is retrieved to align the lighting with the evening setting, promoting a calm and relaxing atmosphere.
Output: A set of raw data, including low-to-moderate lux levels, minimal audio signal data (dB levels), motion index, and time data, reflecting a conducive environment for reading.

### Data Pre-processing

Objective: Clean and normalize the data to ensure it accurately represents a quiet, focused reading environment.

### Process

Noise Filtering (Acoustic): Apply FFT to remove any ambient noise, ensuring the environment remains quiet and conducive to reading.
Light Normalization: Normalize lux readings to maintain consistent lighting that prevents eye strain during prolonged reading.
Motion Data Processing: Smooth motion data to confirm the lack of distractions and steady focus on reading.
Temporal Data Integration: Align time data with the evening setting, reinforcing the relaxed and focused environment.
Output: Pre-processed data that accurately reflects a quiet, well-lit environment conducive to reading.

### Environmental Analysis

Objective: Analyze the pre-processed data to confirm the environment's suitability for quiet reading.

### Process

Environment Classification: Use a decision tree classifier to categorize the environment as “Quiet Reading,” based on low-to-moderate light, minimal noise, and little movement.
Pattern Recognition: Confirm the absence of distractions in audio and motion data, validating the environment's focus-supporting qualities.
Stability Evaluation: Ensure that environmental parameters remain stable to support ongoing reading without interruptions.
Output: Classification of the environment as “Quiet Reading,” providing specific parameters for maintaining a reading-friendly atmosphere.

### Decision and Planning

Objective: Develop a lighting strategy that supports comfortable, extended periods of reading.

### Process

Personalization: Set the lighting to a warm color temperature (e.g., 3000K) and adjust light intensity to 40%, ensuring that the environment is well-lit without causing eye strain.
Transition Planning: Plan for minimal changes in lighting to maintain consistency and avoid distractions while reading.
Dynamic Adaptation: Prepare to make subtle adjustments if environmental noise or movement increases, ensuring continued comfort for reading.
Output: Specific instructions to set the color temperature to 3000K, light intensity to 40%, and maintain consistent lighting to support extended reading.

### Lighting Control

Objective: Implement the lighting strategy to maintain a comfortable reading environment.

### Process

Actuation: Adjust the LED drivers to produce warm, steady lighting with a color temperature of 3000K and an intensity of 40%.
Effect Execution: Maintain consistent lighting with minimal fluctuations, using stable PWM signals to avoid any disruptions.
Real-time Monitoring: Continuously monitor sensor feedback, dynamically adjusting the lighting as necessary to ensure the environment remains conducive to reading.
Output: Actuated lighting system providing warm, steady light, optimizing the environment for comfortable, extended reading sessions.

### 9) Meditation Session

### Scenario Overview

The “Meditation Session” scenario is designed for a peaceful, introspective experience where the user seeks to create a tranquil environment conducive to deep relaxation and mindfulness. The room is softly lit, often with minimal or no artificial light, to avoid distractions. The environment is extremely quiet, with no significant movement, allowing the user to focus inwardly. The objective of the device in this scenario is to maintain a minimal, serene lighting environment that enhances the user's meditative state, supporting deep relaxation and a distraction-free atmosphere.

### Data Sources

### Sensors Data

Ambient Light Sensor: Measures very low light intensity, possibly reflecting the absence of artificial light or very dim settings.
Acoustic Sensor: Captures near-silence, detecting only the faintest background sounds, if any.
Motion Sensor: Detects negligible movement, confirming a stationary and focused state.

### Data Sources

Clock: Provides data to confirm that the session aligns with the user's typical meditation time.

### Data Collection

Objective: Capture real-time environmental data that accurately reflects the meditative environment.

### Process

Ambient Light: Records very low lux values, indicating minimal or no artificial light, consistent with the need for a serene atmosphere.
Acoustic: Collects audio signals to confirm the near-silent environment, focusing on the absence of distracting sounds.
Motion: Monitors negligible movement, confirming the user's stillness during meditation.
Temporal Data: Time data is retrieved to ensure the session aligns with the user's usual meditation schedule.
Output: A set of raw data, including very low lux levels, minimal audio signal data (dB levels), motion index, and time data, reflecting a serene and focused meditative environment.

### Data Pre-Processing

Objective: Process and normalize the data to ensure it accurately represents the calm, meditative environment.

### Process

Noise Filtering (Acoustic): Apply FFT to ensure any minor ambient noise is filtered out, maintaining a silent environment.
Light Normalization: Normalize very low lux readings to ensure consistent minimal lighting, preventing distractions.
Motion Data Processing: Smooth motion data to confirm the lack of movement, ensuring a stable meditative state.
Temporal Data Integration: Align time data with the expected meditation schedule, reinforcing the context. Output: Pre-processed data that accurately reflects a quiet, low-light environment conducive to meditation.

### Environmental Analysis

Objective: Analyze the pre-processed data to confirm the environment's suitability for deep relaxation and meditation.

### Process

Environment Classification: Use a decision tree classifier to categorize the environment as “Meditative,” based on very low light, minimal noise, and negligible motion.
Pattern Recognition: Confirm the absence of distractions in audio and motion data, validating the environment's suitability for deep focus and relaxation.
Stability Evaluation: Ensure that the environmental parameters remain stable to support an uninterrupted meditative state.
Output: Classification of the environment as “Meditative,” providing specific parameters for maintaining a serene atmosphere.

### Decision and Planning

Objective: Develop a lighting strategy that supports deep relaxation and enhances the meditative experience.

### Process

Personalization: Set the lighting to a very low intensity, with a warm color temperature (e.g., 2500K) or allow natural darkness, depending on the user's preferences for meditation.
Transition Planning: Plan for minimal or no changes in lighting, maintaining consistency to avoid any disruptions to the meditative state.
Dynamic Adaptation: Prepare for subtle adjustments if minor environmental changes occur, ensuring continued support for deep relaxation.
Output: Specific instructions to maintain very low light intensity and possibly warm color temperature, ensuring a stable, serene lighting environment.

### Lighting Control

Objective: Implement the lighting strategy to maintain a calm, distraction-free meditative environment.

### Process

Actuation: Adjust the LED drivers to produce very low, warm light (if any) with a color temperature of 2500K or turn off artificial light completely if preferred.
Effect Execution: Maintain consistent minimal lighting with no fluctuations, ensuring the environment remains conducive to meditation.
Real-time Monitoring: Continuously monitor sensor feedback, making dynamic adjustments as necessary to ensure the environment supports deep focus and relaxation.
Output: Actuated lighting system providing very low, warm lighting, or maintaining natural darkness, optimizing the environment for meditation and deep relaxation.

While the invention is susceptible to various modifications and alternative constructions, some preferred embodiments have been shown in the drawings and disclosed in detail.

It should be understood, however, that there is no intention to limit the invention to the specific illustrated embodiment but, on the contrary, the aim is to cover all the modifications, alternative constructions and equivalents falling within the scope of the invention as defined in the claims.

The use of “for example”, “etc.”, “or” indicates non-exclusive alternatives without limitation, unless otherwise indicated.

The use of “includes” means “includes but is not limited to”, unless otherwise stated.

1. Device for generating light signals and/or audio signals inside environments comprising a plurality of sensors arranged for detecting one or more parameters of the environment and/or one or more parameters of one or more users present in the environment in which the device is located, one or more lighting elements and/or one or more elements for emitting an audio signal,
there being a control unit arranged for controlling the activation of the lighting elements and/or of the elements for emitting an audio signal, which control unit comprises at least one processing unit and at least one storage unit,
characterized in that association rules are provided, which association rules are designed to associate the values of the detected parameters with a corresponding condition of the environment, a plurality of conditions of the environment being provided,
the processing unit being configured to:
identify a specific condition of the environment on the basis of the detected parameters,
activate the lighting elements and/or the elements for emitting an audio signal on the basis of the specific condition of the environment.

2. Device according to claim 1, wherein machine learning and artificial intelligence algorithms are loaded inside said control unit, the processing unit being configured to modify said association rules based on the operation of said algorithms.

3. Device according to claim 1, wherein said sensors comprise light sensors and/or acoustic sensors and/or motion sensors and/or temperature sensors and/or humidity sensors and/or vibration sensors and/or Weather sensors.

4. Device according to claim 1, wherein said sensors comprise a communication unit configured to communicate with one or more user devices associated with the users present in the environment.

5. Method for generating light signals and/or audio signals within an environment comprising the following steps:
a) detection of one or more parameters of the environment and/or of one or more parameters of one or more users present in the environment,
b) processing of such parameters,
c) generation of light signals and/or audio signals,
characterized in that
step b) involves the association of the values of the parameters detected in step a) to a specific condition of the environment, step c) being implemented on the basis of the specific condition of the environment associated.

6. Method according to claim 5, wherein step b) involves the generation of associative rules configured for associating the values of the detected parameters with a corresponding condition of the environment.

7. Method according to claim 5, wherein step b) and/or step c) comprises the execution of machine learning and/or artificial intelligence algorithms.

8. Method according to claim 5, wherein, after step c), a step for adjusting the association between the values of the parameters and a specific environmental condition is provided, which adjustment step involves repeating step a).

9. Method according to claim 5, wherein step a) comprises the detection of light parameters and/or acoustic parameters and/or movement parameters and/or temperature parameters and/or humidity parameters /or vibration parameters, and/or weather parameters.

10. Method according to claim 5, wherein step a) comprises the detection of biometric parameters associated with the users present in the environment.

11. Method according to claim 5, wherein step c) is implemented in such a way as to adapt the light signals and/or the audio signals in real time so as to balance the parameters detected in step a).
